(19) United States
(12) Patent Application Publication
(10) Pub. No.: US 2016/0280355 A1
(43) Pub. Date: Sep. 29, 2016

(54) APPARATUS AND METHOD FOR HEAT-SHEILDING FAN DUCT INNER WALL

(71) Applicant: Spirit AeroSystems, Inc., Wichita, KS (US)

(72) Inventor: Rory Lee Deichert, Derby, KS (US)

(73) Assignee: Spirit AeroSystems, Inc., Wichita, KS (US)

(21) Appl. No.: 14/670,020

(22) Filed: Mar. 26, 2015

(51) Int. Cl. B64C 1/40; B32B 37/18; B32B 37/12; B32B 37/14

(52) U.S. Cl. CPC B64C 1/403; B32B 37/144; B32B 37/18; B32B 37/12; B32B 2305/024; B32B 2307/304; B32B 2307/308; B32B 2315/02; B32B 2315/085; B32B 2363/00

(57) ABSTRACT

A system and method for heat shielding an inner wall of a fan duct of an aircraft nacelle from engine heat. The system may include a heat shield and an insulation blanket. The heat shield may have a first layer of high temperature composite material bonded to a first surface of an insulant material and a second layer of high temperature composite material bonded to a second surface of the insulant material. The first layer of high temperature composite material may also be bonded to the inner wall. The insulation blanket may be positioned between the heat shield and the engine, and may be fastened to the heat shield and/or the inner wall.

### BACKGROUND

Commercial airplanes generally have two or more engine nacelles, each including a fan duct formed by walls circumferentially surrounding an engine core and the engine's fan respectively. Aircraft engines radiate intense heat during flight. To ensure that the heat produced by the engine does not adversely affect or damage the fan duct's inner wall, despite its proximity to the engine core, an insulation “blanket” is typically placed between the inner wall of the fan duct and the engine. The insulation blanket is substantially fireproof, typically comprised of an inorganic fibrous insulation material encapsulated between metal foil exterior layers. It is beneficial for an insulation blanket's metallic exterior to directly face the aircraft engine due to its ability to reflect radiant energy, and its ability to serve as a flame barrier. This metallic exterior may also serve as a moisture barrier to prevent the insulation blanket from absorbing engine oil and other fluids. The insulation blanket is typically fastened with various clips or other mechanical fasteners to an inner wall of the fan duct. The insulation blanket may comprise several panels of material that meet at various edges or splices. If the blanket becomes damaged or there is any leakage at these splices, the inner wall of the fan duct may be directly exposed to the engine heat and may be damaged thereby.

### SUMMARY OF THE INVENTION

Embodiments of the present invention solve the above-mentioned problems and provide a distinct advance in the art by providing an improved method of heat shielding an inner wall of an aircraft fan duct or thrust reverser.

One embodiment of the method may include the steps of bonding a first layer of high temperature composite material to a first surface of an insulant material and bonding a second layer of high temperature composite material to a second surface of the insulant material, opposite the first surface. The first and second layers of high temperature composite material and the insulant material may together form a heat shield. Next, the method may include a step of bonding the first layer of high temperature composite material to the inner wall. Then, the method may include a step of positioning an insulation blanket between the heat shield and an aircraft engine. Specifically, the insulation blanket may be positioned such that the heat shield is located between the inner wall and the insulation blanket, with the second layer of high temperature composite material located between the insulant material and the insulation blanket.

In some embodiments of the invention, the method may further include mechanically fastening an insulation blanket to the heat shield and/or the fan duct or thrust reverser, such that the heat shield is located between the inner wall and the insulation blanket. Specifically, the second layer of high temperature composite material may be located between the insulant material and the insulation blanket once the insulation blanket is fastened.

Another embodiment of the invention is a heat shield system for shielding an inner wall of an aircraft fan duct or thrust reverser. The system may include a heat shield and an insulation blanket. The heat shield may include an insulant material with a first surface and a second surface opposite of the first surface, a first layer of high temperature composite material, and a second layer of high temperature composite material. The first layer of high temperature composite material may be bonded to the first surface of the insulant material and may be bondable to the inner wall. The second layer of high temperature composite material may be bonded to the second surface of the insulant material. The insulation blanket may be positioned outward of the second layer of high temperature composite material, such that the second layer of high temperature composite material is located between the insulant material and the insulation blanket. When this heat shield system is installed in the aircraft fan duct or thrust reverser, the heat shield may thus be located between the inner wall and the insulation blanket.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF THE DRAWING FIGURES

Embodiments of the current invention are described in detail below with reference to the attached drawing figures, wherein:

FIG. 1 is a perspective view of an aircraft nacelle into which a heat shielding system illustrated in FIG. 2 may be applied;

FIG. 2 is a cross-sectional schematic view of a heat shielding system constructed according to embodiments of the present invention and shown attached to the fan duct or thrust reverser inner wall of the aircraft nacelle of FIG. 1; and

FIG. 3 is a flow chart illustrating a method of applying heat shielding to the inner wall of the aircraft fan duct in accordance with embodiments of the present invention.

The drawing figures do not limit the current invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the current invention. The following detailed description is, therefore, not to be taken in a limiting sense. The scope of the current invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

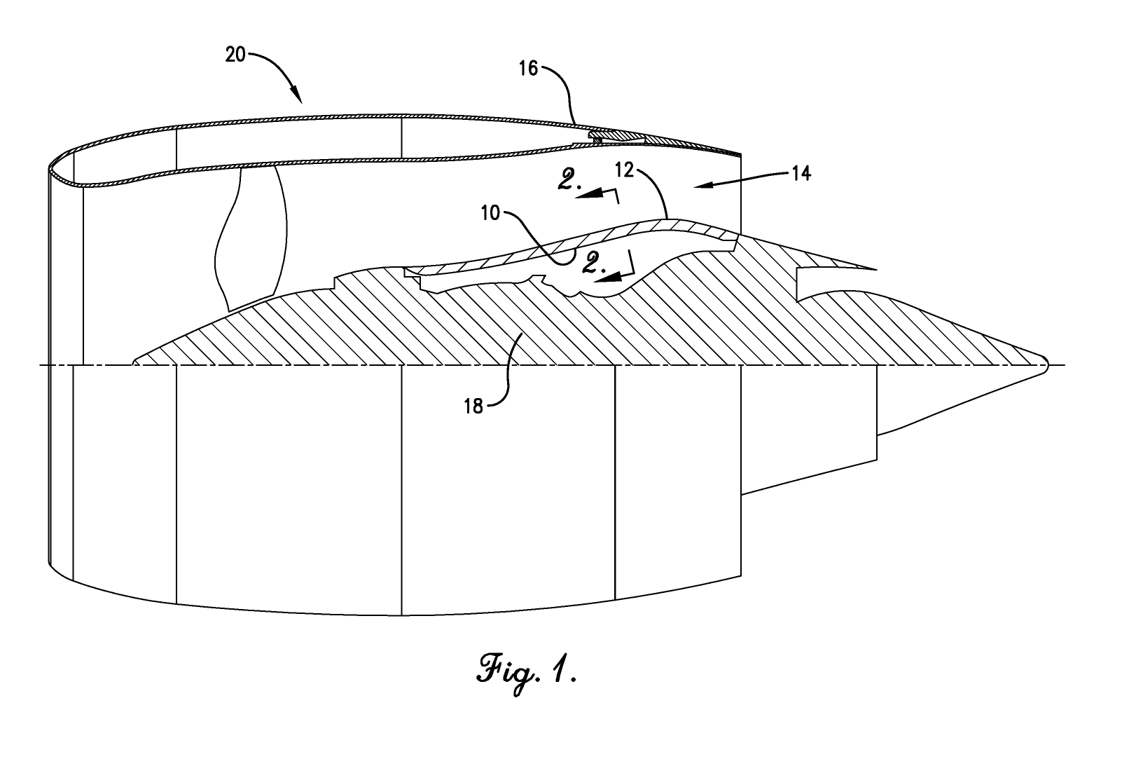

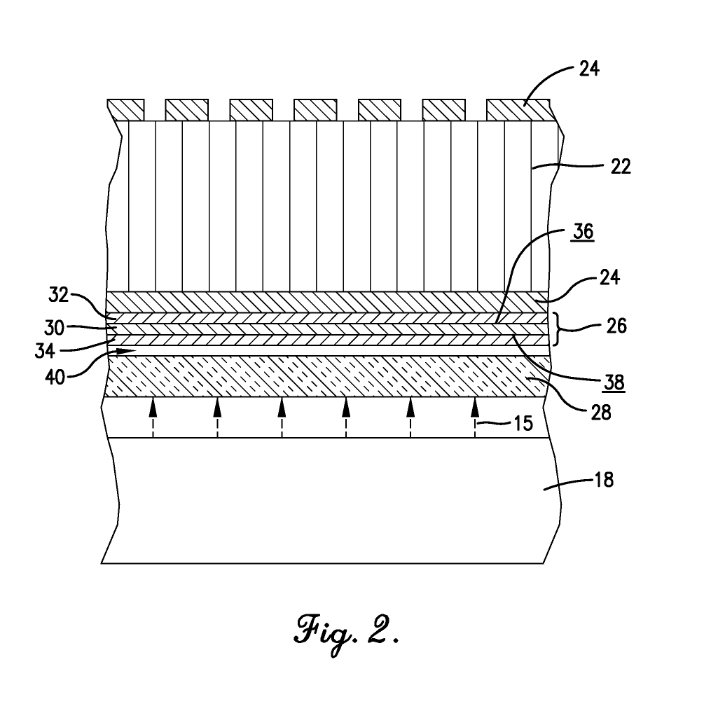

A heat shielding system 10 constructed in accordance with embodiments of the present invention is illustrated in FIGS. 1 and 2. The system 10 is configured for shielding an inner wall 12 of an aircraft fan duct 14 or thrust reverser 16 from heat (illustrated by arrows 15 in FIG. 1) of an aircraft engine 18. An exemplary nacelle 20 illustrated in FIG. 1 depicts the fan duct 14 and thrust reverser 16 circumscribing the aircraft engine 18. The inner wall 12, as illustrated in FIG. 2, may include a honeycomb core 22 sandwiched between two sheets of laminate 24 or graphite-epoxy skin, or may have any other inner wall configurations known in the art. The heat shielding system 10 may be bonded or otherwise attached to the inner wall 12 and may comprise a heat shield 26 and an insulation blanket 28, as illustrated in FIG. 2.

The heat shield 26 may include an insulant material 30, a first layer 32 of high temperature composite material, and a second layer 34 of high temperature composite material. The insulant material 30 may include aluminosilicate fiber paper, ceramic fiber paper, and/or inorganic fiber aggregate material. Furthermore, the insulant material 30 may have a first surface 36 and a second surface 38 opposite of the first surface thereof.

The first layer 32 of high temperature composite material may be bonded to the first surface 36 of the insulant material 30 and bonded or configured to be bonded to the inner wall 12. The second layer 34 of high temperature composite material may be bonded to the second surface 38 of the insulant material 30. For example, adhesive may bond the insulant material 30 with the first and second layers 32,34 of high temperature composite material. Likewise, adhesive may bond the first layer 34 of high temperature composite material to the inner wall 12. However other methods of bonding, such as co-bonding or co-curing, may be used to bond together the components described herein without departing from the scope of the invention.

The first and second layers 32,34 of high temperature composite material may be made of fiberglass reinforced silicone, ceramic fiber reinforced silicone, and/or fiber reinforced elastomer. The first and second layers 32,34 of high temperature composite material may be substantially identical in shape, size, and composition. However, in some embodiments of the invention, the first and second layers 32,34 of high temperature composite material may have different shapes, sizes, and/or compositions from each other.

In some embodiments of the invention, the heat shield 26 may be made of a plurality of alternating layers of high temperature composite material and insulant material. For example, there may be three or four or more layers of high temperature composite material each separated by a layer of insulant material. Each of these insulant material layers may be bonded with adjacent high temperature composite material layers. As with the embodiment illustrated in FIG. 2, one of the high temperature composite material layers may be bonded to the inner wall 12. Any quantity of layers of the heat shield materials described herein may be used without departing from the scope of the invention.

The insulation blanket 28 may be positioned between the aircraft engine 18 and the heat shield 26. Specifically, the insulation blanket 28 may be positioned outward of the second layer 34 of high temperature composite material, such that the second layer 34 is located between the insulant material 30 and the insulation blanket 28, and the heat shield 26 is thus located between the inner wall 12 and the insulation blanket 28, as illustrated in FIG. 2. The insulation blanket 28 may be made of microporous ceramic, inorganic fiber batting, ceramic fiber paper, aerogel, and/or any other insulation blanket material known in the art. A surface of the insulation blanket 28 facing the engine 18 may be composed of metal foil, metalized polymer, or any material selected to reflect infrared radiation, serve as a flame barrier, and/or serve as a moisture barrier. In some embodiments of the invention, the insulation blanket 28 may comprise a plurality of insulation panels (not shown) made of the insulation blanket material(s) described above. These insulation panels of the insulation blanket may be spliced with each other and cooperatively cover at least a majority of the inner wall 12.

The insulation blanket 28 may be mechanically attached to the inner wall 12 and/or the heat shield 26 using any attachment methods and devices known in the art. For example, bolts with heat-resistant covers may be placed through holes in the insulation blanket 28, heat shield 26, and inner wall 12 to fasten the insulation blanket 28 in position between the heat shield 26 and the aircraft engine 18. In some embodiments of the invention, as illustrated in FIG. 2, at least a portion of the insulation blanket 28 may be spaced a distance apart from the second layer 34 of high temperature composite material.

In use, a method for heat shielding the inner wall 12 of the aircraft fan duct 14 and/or thrust reverser 16 may include the steps of bonding the first and second layers 32,34 of high temperature composite material to the first and second surfaces 36,38 of the insulant material 30, respectively, and bonding the first layer 32 of high temperature composite material to the inner wall 12. Once the heat shield 26 is bonded to the inner wall 12, the method may include steps of positioning and/or attaching the insulation blanket 30 to the inner wall 12 and/or heat shield 26, creating dual layers of heat protection between the aircraft engine 18 and the inner wall 12.

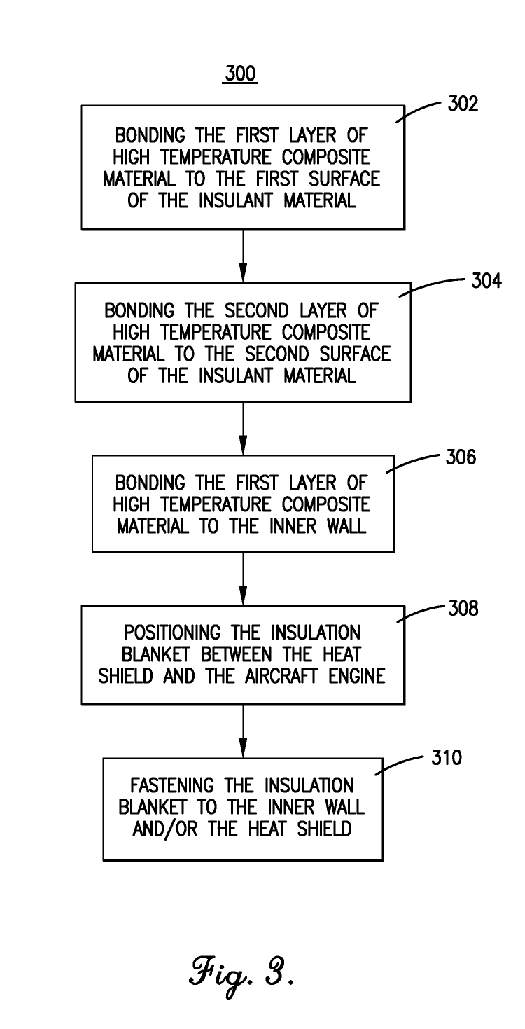

Method steps for heat shielding the inner wall 12 of the aircraft fan duct 14 and/or thrust reverser 16 will now be described in more detail, in accordance with various embodiments of the present invention. The steps of the method 300 may be performed in the order as shown in FIG. 3, or they may be performed in a different order. Furthermore, some steps may be performed concurrently as opposed to sequentially. In addition, some steps may not be performed.

The method 300 may include a step of bonding the first layer 32 of high temperature composite material to the first surface 36 of the insulant material 30, as depicted in block 302, and bonding the second layer 34 of high temperature composite material to the second surface 38 of the insulant material 30, as depicted in block 304. Specifically, steps 302 and 304 form the heat shield 26, which includes the first and second layers 32,34 of high temperature composite material and the insulant material 30.

Next, the method 300 may include a step of bonding the first layer 32 of high temperature composite material to the inner wall 12, as depicted in block 306. As noted above, the bonding steps described herein may be performed using adhesive or any co-curing or co-bonding techniques known in the art. The first layer 32 of high temperature composite material may cover all or a majority of the inner wall 12. However, in some alternative embodiments of the invention, the heat shield 26 may comprise a plurality of heat shield portions (not shown) that are spaced apart from each other when bonded to the inner wall 12. In this alternative embodiment of the invention, these spaced-apart heat shield portions may be centered at locations on the inner wall 12 corresponding to locations of splices between the insulation blanket's individual panels, as described above. Providing the heat shield only in splice areas may advantageously save on overall weight added to the inner wall 12 by the heat shield 26.

Finally, the method 300 may include the steps of positioning the insulation blanket 28 between the heat shield 26 and the aircraft engine 18, as depicted in block 308, and fastening the insulation blanket 28 to the inner wall 12 and/or the heat shield 26, as depicted in block 310. Specifically, the insulation blanket 28 may be positioned such that the heat shield 26 is located between the inner wall 12 and the insulation blanket 28, with the second layer 34 of high temperature composite material located between the insulant material 30 and the insulation blanket 28. As noted above, there may be a gap 40 between portions of the insulation blanket 28 and the heat shield 26, with portions of the insulation blanket 28 spaced a small distance apart from the second layer 34 of high temperature composite material. For example, at locations where the insulation blanket 28 is fastened to the inner wall 12, a gap or space may not exist, but locations inward of these attachment locations may have the gap 40 or a space between the insulation blanket 28 and the second layer 34 of high temperature composite material.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A method of heat shielding an inner wall of a fan duct of an aircraft nacelle, the method comprising:
bonding a first layer of high temperature composite material to a first surface of an insulant material;
bonding a second layer of high temperature composite material to a second surface of the insulant material, wherein the second surface is opposite the first surface, wherein the layers of high temperature composite material and the insulant material together form a heat shield;
bonding the heat shield to the inner wall; and
positioning an insulation blanket such that the heat shield is located between the inner wall and the insulation blanket, with the second layer of high temperature composite material located between the insulant material and the insulation blanket, wherein the insulation blanket comprises different material than the composite material.

2. The method of claim 1, wherein the insulation blanket is made of at least one of microporous ceramic, inorganic fiber batting, ceramic fiber paper, and aerogel.

3. The method of claim 1, wherein the insulant material is at least one of aluminosilicate fiber paper, ceramic fiber paper, and inorganic fiber aggregate material.

4. The method of claim 1, wherein the first and second layers of high temperature composite material are made of at least one of fiberglass reinforced silicone, ceramic fiber reinforced silicone, and fiber reinforced elastomer.

5. The method of claim 1, wherein at least a portion of the insulation blanket is spaced a distance apart from the second layer of high temperature composite material.

6. The method of claim 1, wherein adhesive is used to perform the bonding steps.

7. The method of claim 1, wherein the inner wall comprises a honeycomb core sandwiched between two sheets of laminate or graphite-epoxy skin.

8. The method of claim 1, wherein the first layer comprises a different material than the second layer.

9. The method of claim 1, wherein the insulation blanket comprises a plurality of insulation panels spliced with each other and cooperatively covering a majority of the inner wall.

10. The method of claim 9, wherein the heat shield comprises a plurality of heat shield portions spaced apart from each other and centered at locations on the inner wall corresponding to locations of splices between the insulation panels.

11. A heat shield system for shielding an inner wall of a fan duct of an aircraft nacelle, the heat shield system comprising:
a heat shield including:
an insulant material having a first surface and a second surface opposite of the first surface of the insulant material,
a first layer of high temperature composite material bonded to the first surface of the insulant material and configured to be bonded to the inner wall, and
a second layer of high temperature composite material bonded to the second surface of the insulant material; and
an insulation blanket positioned outward of the second layer of high temperature composite material, such that the second layer of high temperature composite material is located between the insulant material and the insulation blanket, wherein the heat shield is configured to be located between the inner wall and the insulation blanket.

12. The method of claim 11, wherein the insulation blanket is made of at least one of microporous ceramic, inorganic fiber batting, ceramic fiber paper, and aerogel.

13. The method of claim 11, wherein the insulant material is at least one of aluminosilicate fiber paper, ceramic fiber paper, and inorganic fiber aggregate material.

14. The method of claim 11, wherein the first and second layers of high temperature composite material are made of at least one of fiberglass reinforced silicone, ceramic fiber reinforced silicone, and fiber reinforced elastomer.

15. The method of claim 11, wherein at least a portion of the insulation blanket is spaced a distance apart from the second layer of high temperature composite material.

16. The method of claim 11, wherein adhesive bonds the insulant material with the first and second layers of high temperature composite material.

17. The method of claim 11, wherein the first layer comprises a different material than the second layer.

18. A method of heat shielding an inner wall of a fan duct or thrust reverser of an aircraft nacelle, the inner wall comprising a honeycomb core sandwiched between two sheets of laminate or graphite-epoxy skin, the method comprising:
bonding a first layer of high temperature composite material to a first surface of an insulant material;
bonding a second layer of high temperature composite material to a second surface of the insulant material, wherein the second surface is opposite the first surface, wherein the first and second layers of high temperature composite material and the insulant material together form a heat shield;
bonding the first layer of high temperature composite material to the inner wall; and
mechanically fastening an insulation blanket to the heat shield such that the heat shield is located between the inner wall and the insulation blanket, with the second layer of high temperature composite material located between the insulant material and the insulation blanket, wherein the insulation blanket comprises different material than the composite material.

19. The method of claim 18, wherein the insulation blanket is made of at least one of microporous ceramic, inorganic fiber batting, ceramic fiber paper, and aerogel, wherein the insulant material is at least one of aluminosilicate fiber paper, ceramic fiber paper, and inorganic fiber aggregate material, wherein the first and second layers of high temperature composite material are made of at least one of fiberglass reinforced silicone, ceramic fiber reinforced silicone, and fiber reinforced elastomer.

20. The method of claim 18, wherein the insulation blanket comprises a plurality of insulation panels spliced with each other and cooperatively covering a majority of the inner wall, wherein the heat shield comprises a plurality of heat shield portions spaced apart from each other and centered at locations on the inner wall corresponding to locations of splices between the insulation panels.
